(19) United States
(12) Patent Application Publication
(10) Pub. No.: US 2018/0220167 A1
(43) Pub. Date: Aug. 2, 2018

(54) DETERMINING ACTIVITIES FOLLOWING A VIEW OF A SPONSORED VIDEO CONTENT ITEM

(71) Applicants: Lane P. Shackleton, San Francisco, CA (US); Mauricio Zuluaga, Adliswil (CH); Jie Ren, Santa Monica, CA (US); Chao Cai, San Jose, CA (US); Steven G. Dropsho, Zurich (CH); Jonathan Goldman, San Francisco, CA (US)

(72) Inventors: Lane P. Shackleton, San Francisco, CA (US); Mauricio Zuluaga, Adliswil (CH); Jie Ren, Santa Monica, CA (US); Chao Cai, San Jose, CA (US); Steven G. Dropsho, Zurich (CH); Jonathan Goldman, San Francisco, CA (US)

(73) Assignee: GOOGLE INC., Mountain View, CA (US)

(21) Appl. No.: 13/302,840

(22) Filed: Nov. 22, 2011

(51) Int. Cl. H04N 21/23; G06Q 30/02

(52) U.S. Cl. CPC H04N 21/23; G06Q 30/02

(57) ABSTRACT

Methods, systems, and apparatus, including computer programs encoded on a computer-readable storage medium, for tracking activities following a view of a sponsored video content item. A method includes: determining that a user has been presented a sponsored video content item; tracking specific activities after the presentation including identifying activities of the user in a channel associated with the sponsored video content item in a specified time period and attributing the specific activities to the presentation of the sponsored video content item; and surfacing the specific activities to a sponsor of the sponsored video content item.

### BACKGROUND

This specification relates to information tracking and presentation.

The Internet provides access to a wide variety of resources. For example, video and/or audio files, as well as web pages for particular subjects or particular news articles, are accessible over the Internet. Video content items can be presented to users in response to a request, such as request to view a selected video content item by selecting a link or otherwise navigating to a video resource hosted by a video hosting service. Once viewed, a user can perform one or more follow on actions in a same session or over a predetermined time period corresponding to plural sessions. Such activities may be of interest to the sponsor of the video resource or others.

### SUMMARY

In general, one innovative aspect of the subject matter described in this specification can be implemented in methods that include a method for tracking activities following a view of a sponsored video content item. The method comprises: determining that a user has been presented a sponsored video content item; tracking specific activities after the presentation including identifying activities of the user in a channel associated with the sponsored video content item in a specified time period and attributing the specific activities to the presentation of the sponsored video content item; and surfacing the specific activities to a sponsor of the sponsored video content item.

In general, another aspect of the subject matter described in this specification can be implemented in computer program products that include a computer program product embodied in a tangible medium that when executed by a processor cause the processor to: determine that a user has been presented a sponsored video content item; track specific activities after the presentation including identifying activities of the user in a channel associated with the sponsored video content item in a specified time period and attributing the specific activities to the presentation of the sponsored video content item; and surface the specific activities to a sponsor of the sponsored video content item.

In general, another aspect of the subject matter described in this specification can be implemented in systems that include a system for tracking activities following a view of a sponsored video content item. A system includes a content management system, a video sharing system, and a campaign-management user interface. The content management system is configured to: determine that a user has been presented a sponsored video content item in the video sharing system; track specific activities after the presentation including identifying activities of the user in a channel associated with the sponsored video content item in a specified time period and attributing the specific activities to the presentation of the sponsored video content item; and surface the specific activities to a sponsor of the sponsored video content item on the campaign-management user interface.

These and other implementations can each optionally include one or more of the following features. The sponsored video content item can be a paid video advertisement. The activities can include follow on views on the channel. The activities can include unique follow on views. The activities can include subscribing and unsubscribing. The activities can include subscribing and unsubscribing to the channel. The activities can include designating a video, marking a video, sharing a video, embedding a video, or commenting on a video. Tracking can include recording in a view log sponsored views of the sponsored video content item, recording in an activities log activities of a user on a per channel basis, and correlating the view log and the activities log to determine activities that occurred after a paid view was recorded. Surfacing can include enabling the sponsor to designate which activities to surface. Surfacing can include reporting follow on views and subscriptions that occurred after a paid view. Surfacing can include presenting a user interface to the sponsor that identifies the specific activities along with other view data for the sponsored video content item. Tracking can include tracking a last sponsored video content item view in a given channel. The time period can be defined by the sponsor of the sponsored video content item. The time period can be a predetermined time period. The predetermined time period can be, for example, substantially twenty four hours. The predetermined time period can be based on a start and end of a session. The session can be started at a time right after the sponsored video content item is viewed. The session can end at a next start time of a presentation of the sponsored video content item on the channel to the user.

Particular implementations may realize one or more of the following advantages. Activities that occur on a channel after a presentation of a sponsored video content item can be attributed to the video content item. A video content item sponsor can become aware of activities that occur following presentation of a sponsored video content item.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for tracking activities following a view of a sponsored video content item.

FIG. 2 illustrates a series of example user activities.

FIGS. 3 and 4 illustrate example user interfaces.

FIGS. 5 and 6 are flowcharts of example processes for tracking activities following a view of a sponsored video content item.

FIG. 7 is a block diagram of computing devices that may be used to implement the systems and methods described in this document, as either a client or as a server or plurality of servers.

Like reference numbers and designations in the various drawings indicate like elements.

### DETAILED DESCRIPTION

Specific activities performed by a user can be tracked after determining that the user has been presented a sponsored video content item and the specific activities can be attributed to the presentation of the sponsored video content item. For example, activities of the user in a channel associated with the sponsored video content item occurring in a specified time period can be identified. The user can view another video resource on the channel, subscribe to or unsubscribe from the channel, or share or designate a video resource on the channel, to name a few examples. After tracking the specific activities, the specific activities can be surfaced to a sponsor of the sponsored video content item, such as in a user interface or report. Examples of sponsored video content items can include video advertisements. In some implementations, sponsored video content items can include paid video advertisements that include compensation paid by an advertiser to a publisher associated with the paid video advertisement. In some implementations, a paid video advertisement is paid, in that, when viewed, a content management system credits a publisher of the video advertisement while debiting an advertiser associated with the paid video advertisement.

For situations in which the systems discussed here collect information (such as activities of a user) or personal information about users, the users may be provided with an opportunity to opt in/out of programs or features that may collect personal information (e.g., information about a user's preferences or a user's current location). In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, zip code, or state level), so that a particular location of the user cannot be determined.

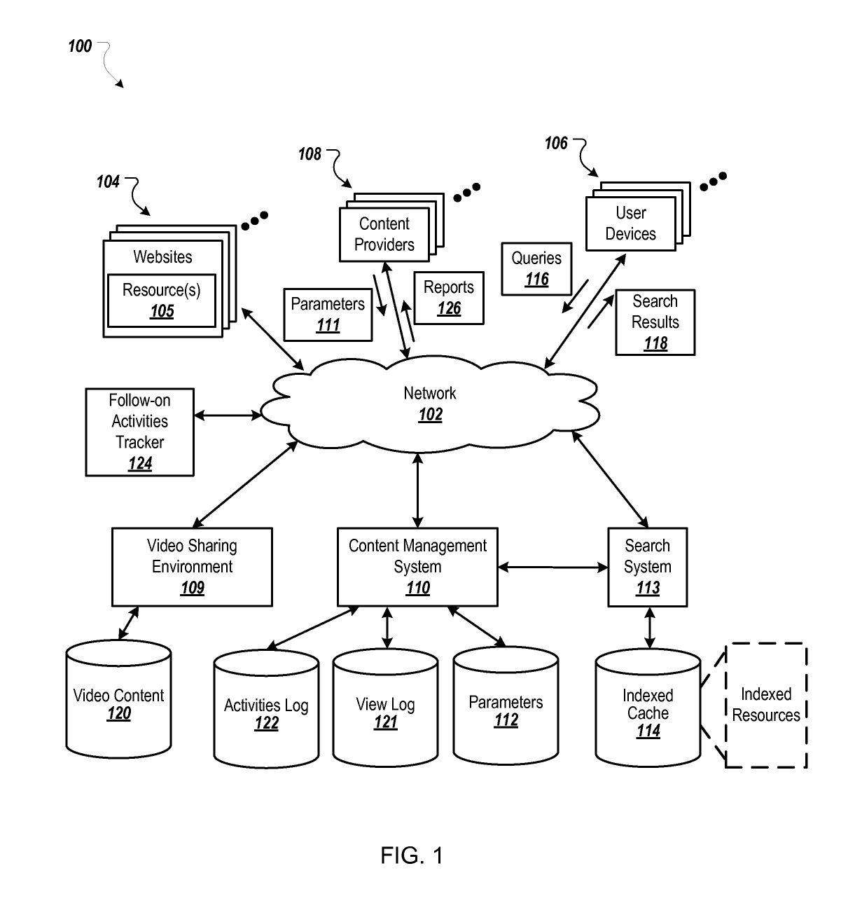

FIG. 1 is a block diagram of an example environment 100 for tracking activities following a view of a sponsored video content item. The example environment 100 includes a network 102, such as a local area network (LAN), a wide area network (WAN), the Internet, or a combination thereof. The network 102 connects websites 104, user devices 106, content providers 108, publishers, a video sharing environment 109, and a content management system 110. The example environment 100 may include many thousands of websites 104, user devices 106, and content providers 108. The content management system 110 may be used for selecting and providing content in response to requests for content.

A website 104 includes one or more resources 105 associated with a domain name and hosted by one or more servers. An example website 104 is a collection of web pages formatted in hypertext markup language (HTML) that can contain text, images, multimedia content, and programming elements, such as scripts. Each website 104 can be maintained by a content publisher, which is an entity that controls, manages and/or owns the website 104.

A resource 105 can be any data that can be provided over the network 102. A resource 105 can be identified by a resource address that is associated with the resource 105. Resources 105 include HTML pages, word processing documents, portable document format (PDF) documents, images, video, and news feed sources, to name only a few. The resources 105 can include content, such as words, phrases, videos, images and sounds, that may include embedded information (such as meta-information hyperlinks) and/or embedded instructions (such as JavaScript scripts).

To facilitate searching of resources 105, the environment 100 can include a search system 113 that identifies the resources 105 by crawling and indexing the resources 105 provided by the content publishers on the websites 104. Data about the resources 105 can be indexed based on the resource 105 to which the data corresponds. The indexed and, optionally, cached copies of the resources 105 can be stored in an indexed cache 114.

A user device 106 is an electronic device that is under control of a user and is capable of requesting and receiving resources 105 over the network 102. Example user devices 106 include personal computers, mobile communication devices (e.g., smartphones), and other devices that can send and receive data over the network 102. A user device 106 typically includes one or more user applications, such as a web browser, to facilitate the sending and receiving of data over the network 102.

The content providers 108 can be, for example, advertisers. Other types of content providers are possible. A content provider 108 or content sponsor can create a content campaign associated with one or more video content items using tools provided by the content management system 110. For example, the content management system 110 can provide one or more account management user interfaces for creating and managing content campaigns. The account management user interfaces can be made available to the content provider 108, for example, either through an online interface provided by the content management system 110 or as an account management software application installed and executed locally at a content provider's client device. The content provider 108 can create, for example, a video campaign or some other type of campaign.

The content provider 108 can, using the account management user interfaces, provide campaign parameters 111 which define the content campaign. The campaign parameters 111 can be stored in a parameters data store 112. Campaign parameters 111 can include, for example, a campaign name, a preferred content network for placing content, a budget for the campaign, start and end dates for the campaign, a schedule for content placements, content (e.g., a creative, such as a video content item), targeting criteria, and one or more settings related to tracking activities following a view of a sponsored video content item (e.g., a paid video advertisement). Targeting criteria can include, for example, a targeted language, one or more targeted geographical locations or websites, and one or more targeting terms.

Settings related to tracking activities following a view of a sponsored video content item can include, for example, a user-specified time period for which to track activities (e.g., activities may be tracked, for example, for one session, or one time period (such as twenty four hours, one week, thirty days, or some other user-specified time amount after a sponsored video content item has been presented)). Other settings may include an indication of which activities to track and/or which activities to display in one or more reports. For example, the content provider 108 can specify to track or to report on views of another video on the same channel as the channel that includes the sponsored video content item (e.g., a “follow-on view”), subscription-related information, sharing of a video, other designations of a video (e.g., “liking”, adding to a favorites), or other activity occurring on the channel that includes the sponsored video content item. The content campaign can be created and activated for the content provider 108 according to the parameters 111 specified by the content provider 108.

The video sharing environment 109 allows users and content providers 108, using the user devices 106, to upload and make available video content items. The video sharing environment 109 may include, for example, multiple channels, where each channel may be associated, for example, with one or more content providers 108, one or more particular users, or a particular type of video content. The content provider 108 can, for example, associate one or more targeting keywords with each video content item that is included in a video campaign and/or can associate a video content item in a video campaign with one or more user video content items that are stored in a repository 120. The content provider 108 can provide, for example, one or more sponsored video content items.

The content provider 108 can provide or identify one or more sponsored video content items (e.g., paid video advertisements) to be used for one or more video campaigns. Different types of video formats can exist, including, but not limited to a search-result-embedded format (e.g., a video that is provided as part of a search result), a selected-from-group format (e.g., a video that is provided in response to a selection made from a slate of available videos), an in-display format (e.g., a video that is provided as a user-selectable thumbnail within a banner or other display), or a stream-embedded format (e.g., a video that is provided before, during or after another content item in a stream). Other types of formats other than video formats can be used, for example, an audio-only format or an audio format that is used with a static image. Other formats are possible.

A user device 106 can, for example, request resources 105 from a website 104. In turn, data representing the resource 105 can be provided to the user device 106 for presentation by the user device 106. As another example, a user device 106 can request a video content item hosted by the video sharing environment 109. As yet another example, user devices 106 can submit search queries 116 to the search system 113 over the network 102 and one or more links to video content items hosted by the video sharing environment can be provided as search results.

In response to a search query 116, the search system 113 can access the indexed cache 114 to identify resources 105 that are relevant to the search query 116. The search system 113 identifies the resources 105 in the form of search results 118 and returns the search results 118 to the user devices 106 in one or more search results pages. In some implementations, a search result 118 is data generated by the search system 113 that identifies a resource 105 that is responsive to a particular search query 116, and includes a link to the resource 105. An example search result 118 can include a web page title or video title, a snippet of text or a portion of an image extracted from the web page or video, and the URL (Unified Resource Location) of the web page.

A request for content can be received by the content management system 110 from a user device 106. The request for content can be associated with, for example, a request for a resource 105, a search query 116, or request for a particular video content item. The content management system 110 can select one or more content items to provide in response to the request. For example, the request for content can include characteristics (e.g., size, supported media types) of one or more content “slots” that are defined for the requested resource 105 or search results page. As another example, resource keywords associated with a requested resource 105 or a search query 116 can be provided to the content management system 110. Content items selected by the content management system 110 can include video content items (e.g., a paid video advertisement) or other content items having characteristics matching the characteristics of content slots and that are identified as relevant to specified resource keywords or search queries 116. For example, content items having targeting keywords that match the resource keywords or the search query 116 can be selected by the content management system 110. The content management system 110 can also select content items at least in part based on the results of an auction. The selected content item(s) can be sent to the user device 106, for presentation on the user device 106.

The presentation of a content item such as a paid video advertisement can be recorded, for example, in a view log 121. Activities of users can be recorded, in an activities log 122, on a per channel basis. A follow-on activities tracker 124 can, such as periodically, correlate the view log 121 and the activities log 124 to determine activities that occurred after a sponsored view was recorded and to attribute the activities to the presentation of the sponsored video content item. For example, for a particular presentation of a paid video advertisement, activities of the user in a channel associated with the paid video advertisement occurring in a specified time period can be identified in the activities log 124. For example, activity log information indicating that the user viewed another video on the channel, subscribed to or unsubscribed from the channel, or shared or designated a video on the channel may be identified, to name a few examples. The identified activities can be surfaced to the content provider 108 who provided the sponsored video content item, such as in one or more reports 126, or in some other user interface, such as a campaign management user interface.

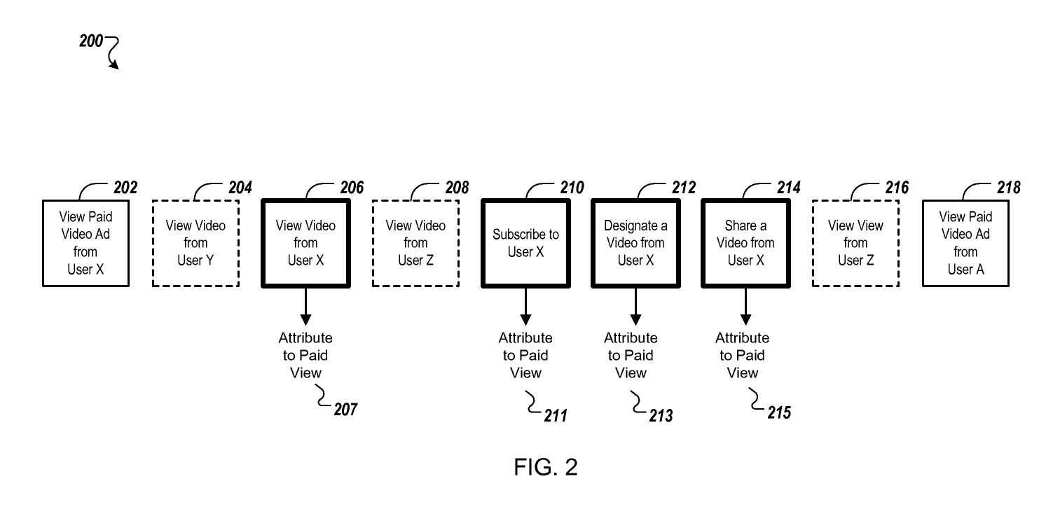

FIG. 2 illustrates a series 200 of example user activities 202-218. The user views a sponsored video content item that has been uploaded by a user “X” (202). Subsequent activities of the user can be tracked in a specified time period and activities occurring in a channel associated with the sponsored video content item can be attributed to the presentation of the sponsored video content item. Activities of the user occurring in the time period that are not associated with the channel might not be attributed to the presentation of the sponsored video content item. For example, the user views videos that have been uploaded by users “Y” (204), “X” (206), and “Z” (208). The viewing of the videos from users “Y” and “Z” are not attributed to the presentation of the sponsored video content item and the viewing of the video from the user “X” is attributed to the sponsored video content item (e.g., as illustrated by text 207).

Activities other than views can be attributed to the sponsored video content item. For example, the user subscribes to the channel associated with the sponsored video content item (210), designates (e.g., “plus one”, “likes”) a video from the user “X” (212), and shares a video from the user “X” (214). Each of these three activities are attributed to the presentation of the sponsored video content item (e.g., as illustrated by text 211, 213, and 215, respectively). The user next views another video from the user “Z” (216), and this view is not attributed to the sponsored video content item. The user next views a sponsored video content item from a user “A” (218). This view is not attributed to the sponsored video content item associated with the user “X”, and, as described above, a new session is initiated that is associated with the presentation of the sponsored video content item for the user “A.” Subsequent activities of the user can be tracked and activities occurring in a channel associated with the sponsored video content item from the user “A” can be attributed to the presentation of the sponsored video content item from the user “A”.

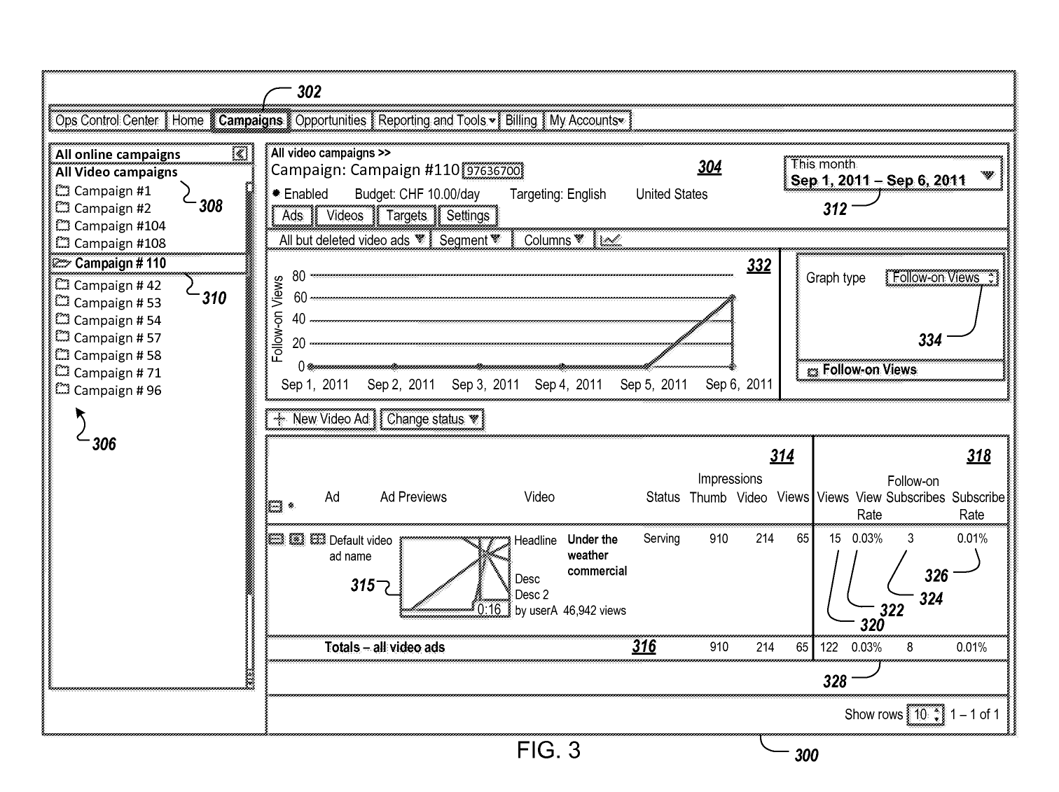

FIG. 3 illustrates an example user interface 300. The user interface 300 can be included, for example, in one or more user interfaces that a user, such as a campaign sponsor, can use to configure a campaign, such as a video campaign. The user can select a tab 302 to display a campaign area 304. The user can view a list 306 of video campaigns by selecting a control 308. The user can edit an existing video campaign in the campaign area 304 by selecting the name of an existing campaign (e.g., a name 310) in the video campaign list 306.

The user can view information for a campaign for a particular time period. For example, the user can select a time range (e.g., Sep. 1 through Sep. 6, 2011) using a control 312. Information for one or more sponsored video content items that are associated with the campaign can be displayed in an area 314. For example, the area 314 displays information for a paid video advertisement 315. Summary information for all sponsored video content items in the campaign can be shown in a totals area 316.

Information about activities that have occurred after presentation of the paid video advertisement 315 can be displayed in an area 318. For example, follow-on views 320, follow-on view rate 322, follow-on subscribes 324, and follow-on subscribe rate 326 are displayed. The follow-on views 320 indicates the total number of views of videos that occurred after presentation of the paid video advertisement 315. The follow-on view rate 322 indicates a ratio of the follow-on views 320 to the number of times the paid video advertisement 315 was presented during the time period indicated by the control 312. The follow-on subscribes 324 indicates the total number of subscriptions to the channel that includes the paid video advertisement 315 that occurred after presentation of the paid video advertisement 315 during the time period indicated by the control 312. The follow-on subscribe rate 326 indicates a ratio of the follow-on subscribes 324 to the number of times that the paid video advertisement 315 was presented during the time period indicated by the control 312.

Summary follow-on information for all sponsored video content items in the campaign can be displayed in an area 328. A graph of follow-on views is displayed in a graph area 330. The user can select other information (e.g., information for subscriptions) to display in the graph area 332 using a control 334. Other information other than follow-on views and subscription information can be displayed in the user interface 300. For example, information for unsubscribes, designations, shares, embeds, and other activities occurring on the channel associated with the paid video advertisement 315 after presentation of the paid video advertisement 315 can be displayed in the user interface 300.

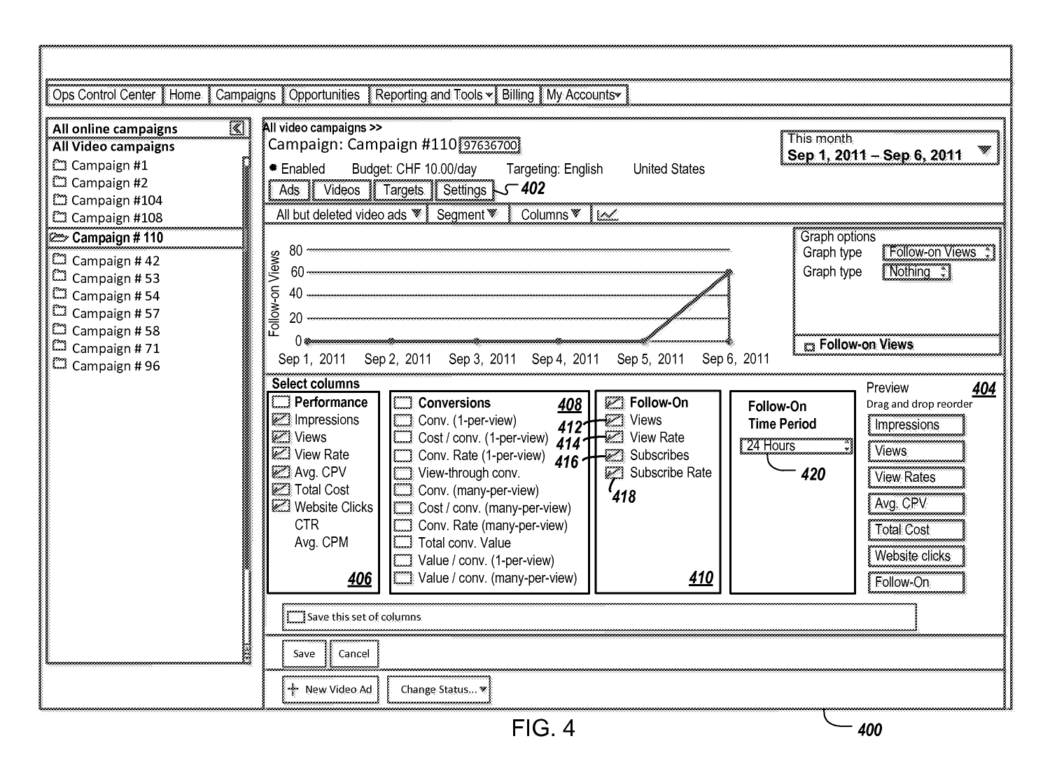

FIG. 4 illustrates an example user interface 400. The user interface 400 can be included, for example, in one or more user interfaces that a user, such as a campaign sponsor, can use to configure a campaign, such as a video campaign. The user can select a control 402 to display a settings area 404. The settings area 404 includes, among other elements, areas 406 and 408 for selecting which performance information items and which conversion information items, respectively, to display in a campaign management interface, such as the user interface 300 described above with respect to FIG. 3.

The settings area 404 also includes a “follow-on” area 410, which enables the user to select which items of information that have been tracked in response to and attributed to the presentation of a sponsored video content item are to be displayed in the campaign management interface. The “follow-on” area 410 includes controls 412, 414, 416, and 418, for selecting whether follow-on views, follow-on view rate, follow-on subscribes, and follow-on subscribe-rate, respectively, are to be displayed in the campaign management interface. In some implementations, the user can select a control 420 to configure a time period used for identifying activities of the user occurring within the time period after a presentation of a sponsored video content item. For example, the user has selected a time period of twenty four hours.

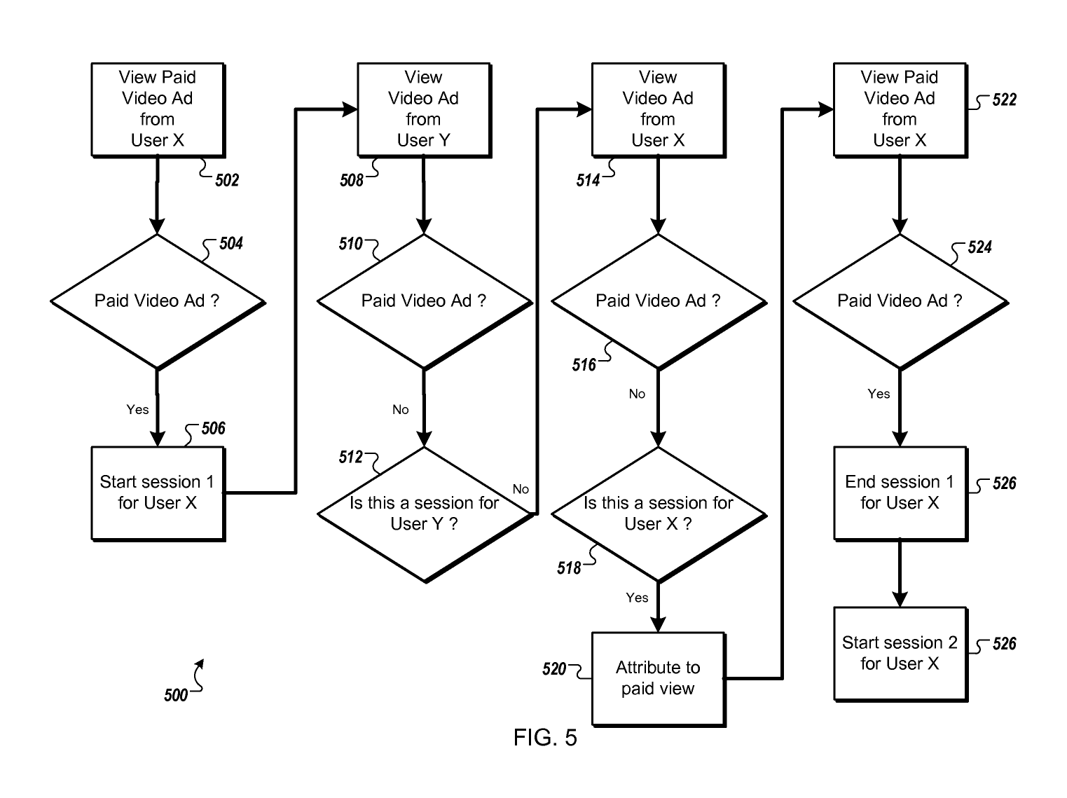

FIG. 5 is a flowchart of an example process 500 for tracking activities following a view of a sponsored video content item. The process 500 can be performed, for example, by the content management system 110 described above with respect to FIG. 1. A user views a video content item provided by a user “X” (502). For example, the user “X” may be an advertiser. It is determined that the viewed video is a sponsored video content item (504). A first session is started, where the first session is associated with the sponsored video content item provided by the user “X” (506).

The user views a video provided by a user “Y” (508, e.g., on a channel associated with the user “Y”). The user “Y” may be, for example, another advertiser, or a non-advertiser user. It is determined that the video provided by the user “Y” is not a sponsored video content item (510). It is determined that there is not a started session associated with the user “Y” (512, e.g., there is a started session associated with the user “X” but not with the user “Y”). The viewing of the video provided by the user “Y” is not attributed to the presentation of the sponsored video content item provided by the user “X”, since the unattributed video is provided by a user different than the user “X” associated with the session started in step 506.

The user views a video provided by the user “X” (514, e.g., on a channel associated with the user “X”). It is determined that the video provided by the user “X” is not a sponsored video content item (516). It is determined that there is a started session associated with the user “X” (518). For example, the session started in step 506 may be identified. The view of the video provided by the user “X” (e.g., in step 514) is attributed to the presentation of the sponsored video content item provided by the user “X” (520). Attributed activities may be subsequently surfaced to the user “X”, for example, in one or more user interfaces available to the user “X”.

The user views a second video content item provided by the user “X” (522). It is determined that the second video content item is a sponsored video content item (524). The first session is ended (526). A second session is started, where the second session is associated with the second sponsored video content item provided by the user “X” (526).

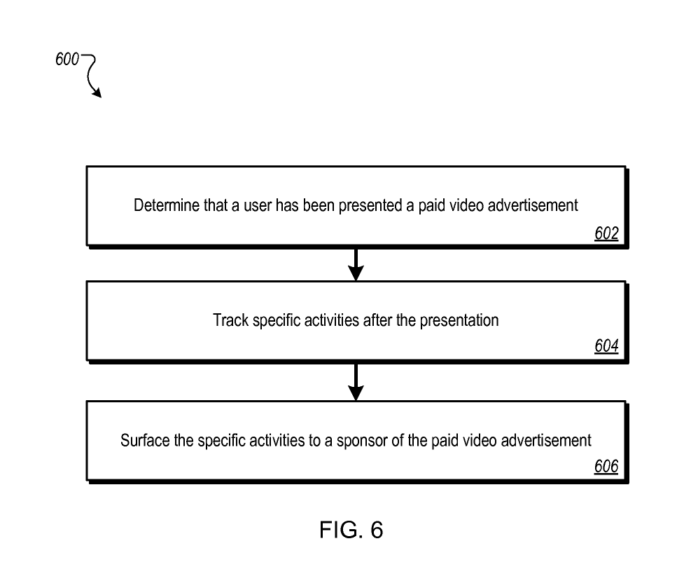

FIG. 6 is a flowchart of an example process 600 for tracking activities following a view of a sponsored video content item. The process 600 can be performed, for example, by the content management system 110 described above with respect to FIG. 1. It is determined that a user has been presented a sponsored video content item (602). For example, with respect to FIG. 2, it may be determined that the user has been presented a sponsored video content item that has been previously uploaded from the user “X”. As another example, with respect to FIG. 3, it may be determined that the user has been presented the paid video advertisement 315.

Specific activities are tracked after the presentation (604). Tracking may include, for example, identifying activities of the user in a channel associated with the sponsored video content item in a specified time period. Tracking may also include attributing the specific activities to the presentation of the sponsored video content item.

The specified time period may be defined, for example, by the sponsor of the sponsored video content item. For example, as illustrated in FIG. 4, the sponsor can configure a time period using the control 420. As another example, the time period may be a predetermined time period. A time period may be predefined, for example, by the content management system 110. For example, the time period may be predefined to be a session or a period of substantially twenty four hours or, as another example, thirty days. In some implementations, the content management system 110 can change a predefined time period to a different amount of time, such as based on monitoring and analyzing of user activity and/or in response to sponsor feedback.

The predetermined time period may be based on a start and an end of a session. For example, a session can be started at a time right after a sponsored video content item is viewed. For example, with respect to FIG. 2, a session can begin when the user views a sponsored video content item associated with the user “X”. The session can end at a next start time of a presentation of a sponsored video content item. For example, with respect to FIG. 2, the session that started with the viewing of the paid advertisement associated with the user “X” can end when the user views a paid advertisement associated with the user “A” (or, as another example, when the user views a second, different sponsored video content item that is associated with the user “X”). The session may include, for example, multiple web browser sessions.

The identified activities can include, for example, follow-on views on the channel. For example, with respect to FIG. 2, after viewing the sponsored video content item associated with the user “X”, the user views a second video (e.g., a follow-on video) from the user “X” and the second view is attributed to the presentation of the sponsored video content item. The follow-on view of a video can occur, for example, on a web page that is associated with the channel (e.g., a “channel page”). As another example, the follow-on view can occur on a web page that is associated with the video or that is otherwise associated with the channel that is associated with the sponsored video content item. For example, an identified follow-on view can occur on a “watch page” that is specific to the video.

In some implementations, the identified activities include unique follow-on views and may not include duplicate follow-on views. For instance, in the example of FIG. 2, in some implementations, if the user views the same follow-on video multiple times, each of the multiple views of the follow-on video are tracked and are attributed to the viewing of the sponsored video content item associated with the user “X”. In some implementations, only the first view of the follow-on video is attributed to the viewing of the sponsored video content item associated with the user “X”.

Activities other than follow-on views can be identified. For example, a user subscribing or unsubscribing to the channel may be identified and may be attributed to the view of the sponsored video content item. As another example, a user sharing the sponsored video content item or another video on the channel may be identified and may be attributed to the view of the sponsored video content item. As yet another example, the user designating the sponsored video content item or another video (e.g., “liking”, adding a video to a favorites list) may be identified and attributed to the view of the sponsored video content item. Other user activities occurring on the channel may be identified and attributed to the view of the sponsored video content item, such as the user embedding a video.

In some implementations, paid views of the sponsored video content item are recorded in a view log. Activities of a user may be recorded in an activities log (e.g., a log separate from the view log), on a per channel basis. A last sponsored video content item view may be tracked in a given channel (e.g., in the view log) and the view log may be correlated with the activities log to determine activities that occurred after the paid view was recorded. Correlation may occur periodically (e.g., every hour).

In some implementations, activities other than activities occurring in the channel associated with the sponsored video content item can be tracked and attributed to the view of the sponsored content item. For example, activities occurring on other web pages associated with the sponsor of the sponsored content item can be tracked. For example, user visits to and user activities occurring on a blog or a social media site associated with the sponsor in the specified time period can be tracked.

In some implementations, the tracked activities can be attributed to views of other sponsored content items other than the sponsored content item. For example, the content management system 110 can attribute the tracked activities to each of multiple (e.g., five) of the most recently viewed sponsored content items. The attribution can be weighted equally among the multiple recently viewed sponsored content items. As another example, a weighted attribution formula that gives more attribution to the most recently viewed sponsored content items can be used. For example, for the five most recently viewed sponsored content items, attribution weights of 40%, 30%, 15%, 10%, and 5% can be applied, respectively, with the most recently viewed sponsored content item receiving 40% of the weight.

Referring again to FIG. 6, the specific activities are surfaced to a sponsor of the sponsored video content item (606). If the identified activities include, for example, follow-on views and subscriptions, a report may be presented to the sponsor that includes, for one or more sponsored video content items, follow on views and subscriptions that occurred after a view of a respective sponsored video content item. A user interface may be presented to the sponsor that identifies the specific activities along with other view data for the sponsored video content item. For example, with respect to FIG. 3, information for specific activities that occurred after presentation of the paid video 315 are displayed in the follow-on view area 318, along with other view data for the paid video advertisement 315 that is displayed in the area 314. In some implementations, the sponsor is enabled to designate which activities to surface. For example, with respect to FIG. 4, the sponsor can designate which activities to surface using the area 410.

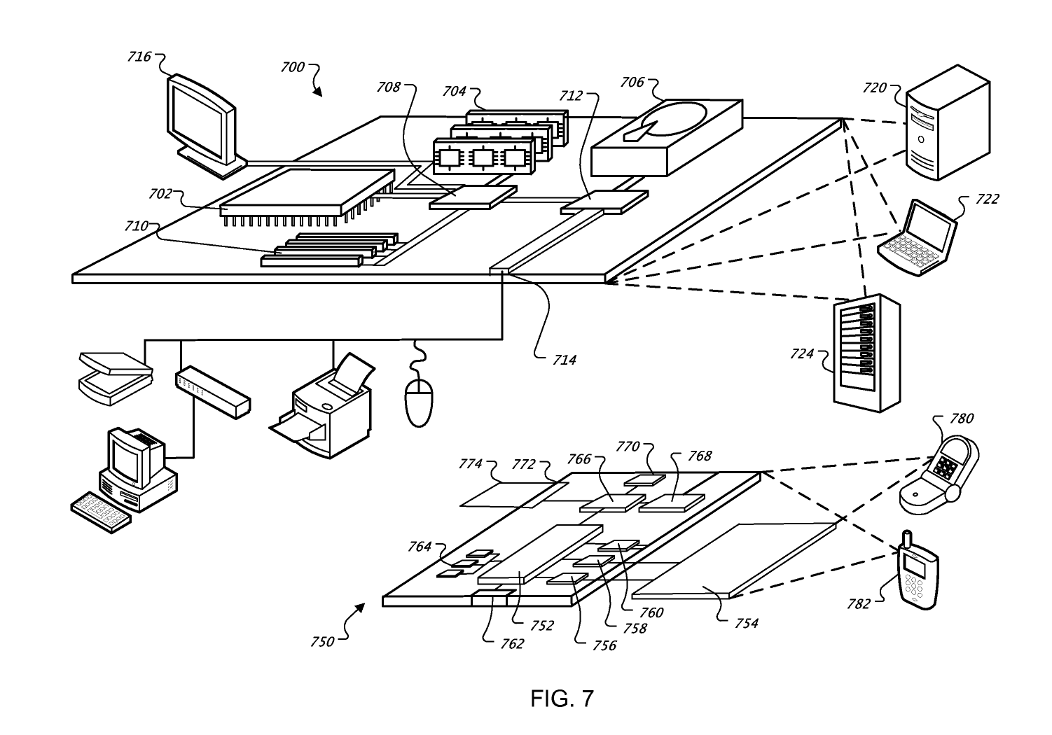

FIG. 7 is a block diagram of computing devices 700, 750 that may be used to implement the systems and methods described in this document, as either a client or as a server or plurality of servers. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a computer-readable medium. In one implementation, the memory 704 is a volatile memory unit or units. In another implementation, the memory 704 is a non-volatile memory unit or units.

The storage device 706 is capable of providing mass storage for the computing device 700. In one implementation, the storage device 706 is a computer-readable medium. In various different implementations, the storage device 706 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 704, the storage device 706, or memory on processor 702.

The high speed controller 708 manages bandwidth-intensive operations for the computing device 700, while the low speed controller 712 manages lower bandwidth-intensive operations. Such allocation of duties is exemplary only. In one implementation, the high-speed controller 708 is coupled to memory 704, display 716 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can process instructions for execution within the computing device 750, including instructions stored in the memory 764. The processor may also include separate analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD display or an OLED display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication (e.g., via a docking procedure) or for wireless communication (e.g., via Bluetooth or other such technologies).

The memory 764 stores information within the computing device 750. In one implementation, the memory 764 is a computer-readable medium. In one implementation, the memory 764 is a volatile memory unit or units. In another implementation, the memory 764 is a non-volatile memory unit or units. Expansion memory 774 may also be provided and connected to device 750 through expansion interface 772, which may include, for example, a SIMM card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, or memory on processor 752.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, WiFi, or other such transceiver (not shown). In addition, GPS receiver module 770 may provide additional wireless data to device 750, which may be used as appropriate by applications running on device 750.

Device 750 may also communication audibly using audio codec 760, which may receive spoken information from a user and convert it to usable digital information. Audio codex 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 750.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A method comprising:
determining, by a processing device, that a user has watched a sponsored video content item pertaining to a channel;
determining, by the processing device, specific activities of the user after the user watching of the sponsored video content item, wherein determining the specific activities comprises:
identifying, by the processing device, the specific activities of the user that are to be determined and a specified time period for performing the determining, the specified time period having a predetermined fixed duration,
after the user watched the sponsored video content item, determining which of the specific activities have occurred with respect to the channel associated with the sponsored video content item during the specified time period after the user watching of the sponsored video content item, and
attributing, by the processing device, the specific activities of the user to the user watching of the sponsored video content item; and
surfacing, by the processing device, the specific activities of the user to a sponsor of the sponsored video content item.

2. The method of claim 1, where the sponsored video content item is a paid video advertisement.

3. The method of claim 1 where the specific activities include follow on views on the channel.

4. The method of claim 3 where the specific activities include unique follow on views.

5. The method of claim 1 where the specific activities include subscribing and unsubscribing.

6. The method of claim 5 where the specific activities include subscribing and unsubscribing to the channel.

7. The method of claim 1 where the specific activities include designating a video, marking a video, sharing a video, embedding a video, or commenting on a video.

8. The method of claim 1 where determining the specific activities further comprises recording in a view log sponsored views of the sponsored video content item, recording in an activities log activities of a user on a per channel basis, and correlating the view log and the activities log to determine activities that occurred after a paid view was recorded.

9. The method of claim 1 where surfacing includes enabling the sponsor to designate which activities to surface.

10. The method of claim 1 where surfacing includes reporting follow on views and subscriptions that occurred after a paid view.

11. The method of claim 1 where surfacing includes presenting a user interface to the sponsor that identifies the specific activities along with other view data for the sponsored video content item.

12. The method of claim 1 where determining the specific activities includes tracking a last sponsored video content item view in a given channel.

13. The method of claim 1 where the time period is defined by the sponsor of the sponsored video content item.

14. The method of claim 1 where the time period is a predetermined time period.

15. The method of claim 14 where the predetermined time period is substantially twenty four hours.

16. The method of claim 14 where the predetermined time period is based on a start and end of a session.

17. The method of claim 16 where the session is started at a time right after the sponsored video content item is viewed.

18. The method of claim 16 where the session ends at a next start time of a presentation of the sponsored video content item on the channel to the user.

19. A non-transitory computer readable medium having instructions stored thereon that, when executed by a processor, cause the processor to:
determine that a user has watched a sponsored video content item pertaining to a channel;
determine=specific activities of the user after the user watching of the sponsored video content item, wherein determining the specific activities comprises:
identifying the specific activities of the user that are to be determined and a specified time period for performing the determining, the specified time period having a predetermined fixed duration,
after the user watched the sponsored video content item, determining which of the specific activities have occurred with respect to the channel associated with the sponsored video content item during the specified time period after the user watching of the sponsored video content item, and
attributing the specific activities of the user to the user watching of the sponsored video content item; and
surface the specific activities of the user to a sponsor of the sponsored video content item.

20. The computer program product of claim 19 where the sponsored video content item is a paid video advertisement.

21. The computer program product of claim 19 where the specific activities include follow on views on the channel.

22. The computer program product of claim 21 where the specific activities include unique follow on views.

23. The computer program product of claim 19 where the specific activities include subscribing and unsubscribing.

24. The computer program product of claim 23 where the specific activities include subscribing and unsubscribing to the channel.

25. A system comprising:
a memory; and
a processing device, coupled to the memory, to:
determine that a user has watched a sponsored video content item pertaining to a channel;
determine specific activities of the user after the user watching of the sponsored video content item, wherein to determine the specific activities, the processing device is to:
identify the specific activities of the user that are to be determined and a specified time period for performing the determining, the specified time period having a predetermined fixed duration,
after the user watched the sponsored video content item, determine which of the specified activities have occurred with respect to the channel associated with the sponsored video content item during the specified time period after the user watching of the sponsored video content item, and
attribute the specific activities of the user to the user watching of the sponsored video content item; and
surface the specific activities to a sponsor of the sponsored video content item on the campaign-management user interface.

26. The system of claim 25 where the sponsored video content item is a paid video advertisement.

27. The system of claim 25 where the specific activities include follow on views on the channel.

28. The system of claim 27 where the specific activities include unique follow on views.

29. The system of claim 25 where the specific activities include subscribing and unsubscribing.

30. The system of claim 29 where the specific activities include subscribing and unsubscribing to the channel.
